(19) United States
(12) Patent Application Publication
(10) Pub. No.: US 2006/0147135 A1
(43) Pub. Date: Jul. 6, 2006

(54) Hydrodynamic bearing motor

(75) Inventor: Sang Uk Kim, Seoul (KR)

Correspondence Address: THELEN REID & PRIEST, LLP, P. O. BOX 640640, SAN JOSE, CA, 95164-0640, US

(73) Assignee: G&W Technologies, Inc.

(21) Appl. No.: 11/322,632

(22) Filed: Dec. 30, 2005

(30) Foreign Application Priority Data
Jan. 3, 2005 (KR) 10-2005-0000074

(51) Int. Cl. F16C 32/06

(52) U.S. Cl. 384/107

(57) ABSTRACT

Provided is a hydrodynamic bearing motor. The hydrodynamic bearing motor, wherein oil journal bearings are formed between a shaft and a sleeve, includes: an upper thrust cover that is fitted over a top portion of the shaft and has an annular rib; a fixture that is secured to a bottom portion of the shaft and has a receiving rib; an upper capillary seal that is defined between an outer circumference of the top portion of the sleeve and the annular rib and retains oil by capillary action; and a lower capillary seal that is defined between an outer circumference of the bottom portion of the sleeve and an inner circumference of the receiving rib and retains oil by capillary action. The hydrodynamic bearing motor provides improved operating characteristics by preventing leakage of oil despite expansion of air bubbles and balancing the pressure between bearings and has improved driving characteristics due to a sufficient journal bearing length.

### CROSS-REFERENCE TO RELATED PATENT APPLICATION

This application claims the benefit of Korean Patent Application No. 10-2005-0000074, filed on Jan. 3, 2005, in the Korean Intellectual Property Office, the disclosure of which is incorporated herein in its entirety by reference.

### BACKGROUND OF THE INVENTION

1. Field of the Invention

The present invention relates to a hydrodynamic bearing motor, and more particularly, to a hydrodynamic bearing motor having improved operating characteristics, by preventing leakage of oil despite expansion of air bubbles and balancing the pressure between bearings, and improved driving characteristics, by providing sufficient journal bearing length.

2. Description of the Related Art

To improve the performance of computer hard disk drives various design techniques to achieve higher track density, reduced noise level, and better stability against external factors such as shocks and vibrations must be used.

Commonly used ball bearings can adversely affect the drive's performance because they generate irregular vibrations, large noise, and have high resonance frequencies caused by bearing defects.

The use of a non-contact bearing such as a hydrodynamic bearing may overcome the above problems. A fluid bearing filled with a thin oil film provides significantly lower irregular vibrations and noise and high resistance to external shocks and vibrations due to its high damping ability. A hydrodynamic bearing system in a hard disk drive must be designed to prevent leakage of oil under all operating and non-operating conditions in order to prevent degradation of bearing performance and contamination of the drive.

FIG. 1 illustrates a hydraulic bearing unit designed to prevent leakage of oil, which is disclosed in U.S. Pat. No. 5,876,124.

Referring to FIG. 1, the hydrodynamic bearing unit includes a base 112, a shaft 114 having a bottom portion press fitted into the base 112 and a top portion secured to a cover 110, a thrust plate 184 and a seat plate 185a having inclined surfaces that are adhesively secured to the top portion of the shaft 114, and a seal plate 165 having inclined surfaces and press fitted over the bottom portion of the shaft 114.

An inner sleeve 194 is fitted over the shaft 114 with a clearance between the thrust plate 184 and the seal plate 165 to rotate freely about the shaft 114. An outer sleeve 195 and a hub 128 are located at the outside of the inner sleeve 194 and the hub 128 is fitted over the outer sleeve 195. A thrust bushing 186 providing a thrust bushing surface is located between the seat plate 185a and the thrust plate 184 and secured on an inside surface of the outer sleeve 195. The thrust bushing 186 has a hole 171 connected to an upper capillary seal 150, which will be described below.

A top clamp ring 187 is adhesively secured to a top portion of the outer sleeve 195 and defines the upper capillary seal 150 (see FIG. 2) with the inclined surface of the seat plate 185a. A bottom clamp ring 167 is adhesively secured to a 15 bottom portion of the outer sleeve 195 and defines a lower capillary seal 151 (See FIG. 3) with the inclined surface of the seal plate 165. Upper and lower coverings 160a and 160b are adhesively mounted to the top and bottom clamp rings 187 and 167, respectively, so as to create a clearance between an inside surface and either the seat plate 185a or the shaft 114.

The hydrodynamic bearing unit having the above-mentioned structure has a clearance between the upper/lower capillary seal 150 or 151 and the inside surface of the upper/lower covering 160a or 160b, thus preventing leakage of oil due to capillary action when a motor does not operate. Furthermore, during operation, the leakage of oil can also be prevented because oil is introduced into bearings by a centrifugal force.

However, one drawback of the hydrodynamic bearing structure is that oil trapped in the capillary seals 150 and 151 or retained in the clearances may escape when air bubbles, generated when the motor operates and the internal temperature thereof increases due to heat generated by friction or an operation of an electromagnetic element, expand and are discharged into the air.

Another drawback is that a pressure difference occurs between upper and lower journal bearings 134 due to air bubbles generated at the journal bearings 134 defined between the inner sleeve 194 and the shaft 114.

Finally, another drawback is that it is difficult to provide sufficient journal bearing length because the upper and lower capillary seals 150 and 151 are located at the top and bottom portions of the shaft 114, respectively.

### SUMMARY OF THE INVENTION

The present invention provides a hydrodynamic bearing motor with an improved structure that can uniformly maintain a pressure between upper and lower bearings and prevent leakage of oil despite air bubbles generated when operating.

The present invention also provides a hydrodynamic bearing motor that can effectively prevent leakage under operating and non-operating conditions.

The present invention also provides a hydrodynamic bearing motor that can inject a constant amount of oil.

The present invention also provides a hydrodynamic bearing motor that enables a stable operation by providing a sufficient journal bearing length in spite of having a structure for preventing leakage of oil at top and bottom portions of a shaft.

According to an aspect of the present invention, there is provided a hydrodynamic bearing motor wherein a sleeve rotates with respect to a shaft via upper and lower oil journal bearings formed between the shaft and the sleeve, including: an upper thrust cover that is fitted over a top portion of the shaft, forms an upper thrust bearing with a top portion of the sleeve, and has an annular rib extending downward to enclose the top portion of the sleeve; a fixture that is secured to a bottom portion of the shaft, forms a lower thrust bearing with a bottom portion of the sleeve and has a receiving rib extending upward to enclose the bottom portion of the sleeve; an upper capillary seal that is defined between an outer circumference of the top portion of the sleeve and the annular rib, communicates with the upper thrust bearing, and retains oil by capillary action; and a lower capillary seal that is defined between an outer circumference of the bottom portion of the sleeve and an inner circumference of the receiving rib, communicates with the lower thrust bearing, and retains oil by capillary action.

The upper capillary seal tapers toward the top portion of the sleeve and the lower capillary seal tapers toward the bottom portion of the sleeve.

An annular flange extends from a top edge of a hub to form an upper gap with a top edge of the thrust cover and an annular gap is formed between an inside diameter surface of the hub and an outside surface of the annular rib.

A pressure balancing hole is formed in the annular rib of the thrust cover to allow communication between the upper capillary seal and the upper gap. An oil storing groove is formed in an outer circumference of the annular rib in contact with the annular gap.

The shaft has an intake hole communicating with an oil gap between the upper and lower journal bearings, a discharge hole communicating with the atmosphere, and a communicating hole connecting the intake hole and the discharge hole. The fixture has a connecting hole providing a passage between the discharge hole and the atmosphere.

The hydrodynamic bearing motor of the present invention allow air bubbles generated during operation and expanding due to internal heat to be discharged into the atmosphere through the discharge hole, thus preventing leakage of oil while improving driving characteristics by balancing the pressure between the upper and lower journal bearings. Furthermore, when the motor stops operating, the capillary seals serve to prevent leakage of oil. The pressure balancing hole also prevents leakage of oil by smoothly discharging the air bubbles. Because the capillary seals can be used to check the amount of injected oil, an accurate amount of oil can be injected.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of a conventional hydrodynamic bearing motor;

FIGS. 2 and 3 are enlarged views of the main portions shown in FIG. 1;

FIG. 4 is a cross-sectional view of a hydrodynamic bearing motor according to an embodiment of the present invention;

FIGS. 5-7 are enlarged views of the main portions shown in FIG. 4;

FIG. 8 is a cross-sectional view showing a main portion of a hydrodynamic bearing motor according to another embodiment of the present invention; and

FIG. 9 is a cross-sectional view of journal bearings according to an embodiment of the present invention.

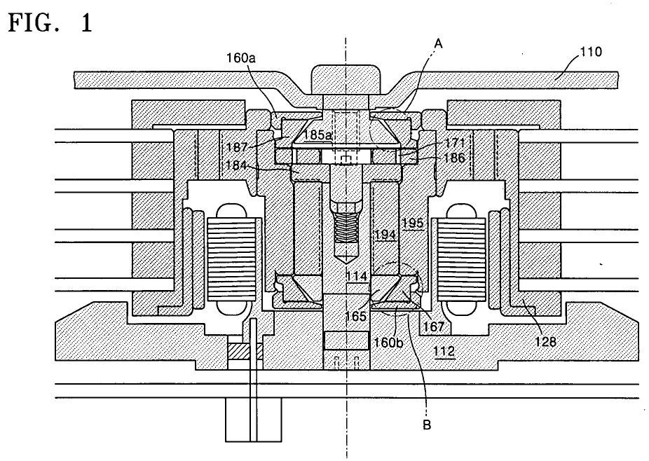

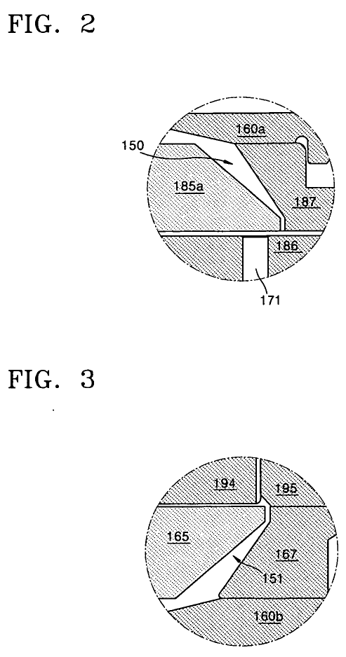

### DETAILED DESCRIPTION OF THE INVENTION

The present invention will now be described more fully with reference to the accompanying drawings, in which exemplary embodiments of the invention are shown.

A hydrodynamic bearing motor according to the present invention prevents leakage of oil due to a capillary action when not operating. When operating, the hydrodynamic bearing motor prevents oil from leaking due to expanded air bubbles while balancing a pressure between upper/lower bearings by smoothly discharging the air bubbles generated at the upper/lower bearings.

The hydrodynamic bearing motor of the present invention also provides sufficient journal bearing length compared to other motors of the same size, thus allowing a stable operation.

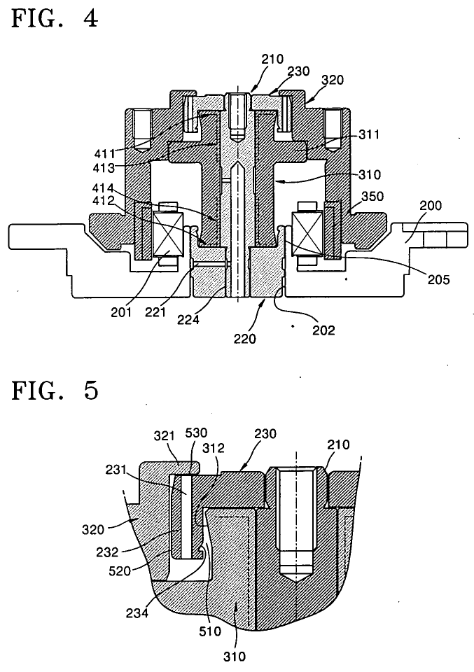

Referring to FIGS. 4-7, a hydrodynamic bearing motor according to an embodiment of the present invention has a structure in which a hydrodynamic bearing is formed in an oil gap between a rotor and a fixed stator to rotatably support the rotor and oil grooves are formed in corresponding surfaces of the rotor and the stator.

The fixed stator includes a base 200 having a fixing hole 202 in the center and a stator 201 fixed onto the outer circumference of the fixing hole 202, and a fixture 220 that is fitted into the fixing hole 202 and has an insert hole 224 in the center, an upwardly extending receiving rib 224 formed at a top edge and a gap 205 formed with the fixing hole 202 and communicating with the atmosphere 500, a shaft 210 fit into the insert hole 224, and a thrust cover 230 that is fitted over a top portion of the shaft 210 having an annular rib 232 extending downward from top edges thereof.

The rotor includes a sleeve 310 rotatably secured to the shaft 210 to define upper and lower journal bearings 413 and 414 and to form upper and lower thrust bearings 411 and 412 between the thrust cover 230 and the fixture 220, and an annular jaw formed on an upper outer circumference thereof and a hub 320 that is fitted onto the outer circumference of the annular stopper 311 of the sleeve 310 and has a magnet 350 that is disposed opposite the stator 201 and fixed to an inner circumference thereof.

The shaft 210 has an intake hole 213 communicating with the oil gap between the upper and lower journal bearings 413 and 414, a discharge hole 214 communicating with the atmosphere 500, and a communicating hole 215 connecting the intake hole 213 and the discharge hole 214. The fixture 220 has a connecting hole 221 providing a passage between the discharge hole 214 and the atmosphere 500.

The hydrodynamic bearing motor having the above-mentioned construction allows air bubbles formed in the oil gap to be discharged into the atmosphere 500 through the intake hole 213, the communicating hole 215, the discharge hole 214, the connecting hole 221, and the gap 205.

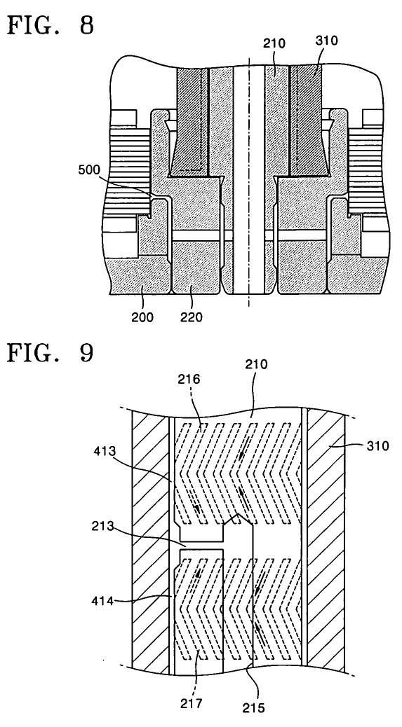

FIG. 8 is a cross-sectional view showing a main portion of a hydrodynamic bearing motor according to another embodiment of the present invention. Referring to FIG. 8, the discharge path for air bubbles is provided to allow the connecting hole 221 to communicate directly with the atmosphere 500 by making the gap 205 between the fixing hole 202 of the base 200 and the fixture 220 larger than in the previous embodiment.

FIG. 9 is a cross-sectional view of the upper and lower journal bearings 413 and 414. Referring to FIG. 9, when the sleeve 310 rotates, the upper and lower journal bearings 413 and 414 allow oil to flow along herringbone-shaped oil grooves 216 and 217 formed in the outer circumferences of the sleeve 310 and/or the shaft 210 and to concentrate in a direction indicated by solid arrow, thus creating a dynamic pressure. The intake hole 213 is formed in a negative pressure generating portion between the upper and lower journal bearings 413 and 414 to receive air bubbles moving in the direction indicated by dolted arrows and collected at the negative pressure generating portion.

Meanwhile, the hydrodynamic bearing motor of the present invention is constructed to prevent leakage of oil during operation and non-operation. To accomplish this purpose, the hydrodynamic bearing motor includes upper and lower capillary seals 510 and 511 located at top and bottom portions of the sleeve 310 and an annular gap 520 and an upper gap 530 formed between the trust cover 230 and the hub 320, thus utilizing a capillary action and a centrifugal force to prevent leakage of oil.

That is, referring to FIGS. 4-6, the upper capillary seal 510 is defined between an angled surface 312 formed at an outer circumference of the top portion of the sleeve 310 with a diameter increasing toward the top portion of the sleeve 310 and an inside surface of the annular rib 232.

The upper capillary seal 510 tapers toward the top portion of the sleeve 310 while the lower capillary seal 511 tapers toward the bottom portion of the sleeve 310. Referring to FIG. 5, the upper capillary seal 510 uses a capillary action to prevent leakage of oil when the motor stops working. During operation, the upper capillary seal 510 utilizes a centrifugal force to allow oil to move upward along the upwardly angled surface 312 to the upper thrust bearing 411, thus preventing leakage of oil.

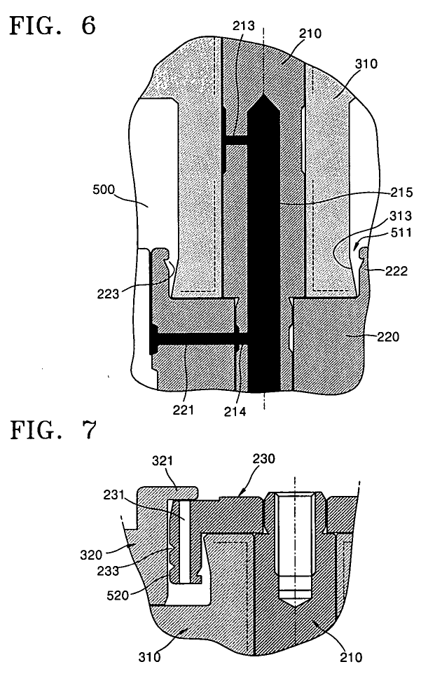

Referring to FIG. 6, the lower capillary seal 511 is defined between an angled surface 313 formed at an outer circumference of the bottom portion of the sleeve 310 with a diameter increasing toward the bottom portion of the sleeve 310 and an inside surface of the receiving rib 222. The lower capillary seal 511 can utilize a capillary action to prevent leakage of oil when the motor stops working. During operation, the lower capillary seal 511 utilizes a centrifugal force to allow oil trapped therein to move toward the lower thrust bearing 412, thus preventing leakage of oil.

Furthermore, inner grooves 234 and 223 are formed in the inside surfaces of the annular rib 232 and receiving rib 222 of the fixture 220 to store oil escaping from the upper and lower capillary seals 510 and 511, thus alleviating oil leakage.

The annular gap 520 and the upper gap 530 serve to finally prevent oil confined in the upper capillary seal 510 from leaking due to external shocks or vibrations.

Air bubble expanding due to heat generated when the motor operates is discharged through two opposite ends of the shaft 210. A pressure balancing hole 231 is formed in the annular rib 232 and allows the upper capillary seal 510 to communicate with the atmosphere 500 in order to prevent contamination due to oil confined in the gaps 520 and 530 and leaking out together with the air bubbles. The pressure balancing hole 231 allows the expanded air bubbles to smoothly escape, thus preventing oil confined within the gaps 520 and 530 from leaking due to the escaping air bubbles.

Furthermore, as shown in FIG. 7, an oil storing groove 233 is formed in an outer circumference of the annular rib 232 in contact with the annular gap 520 in order to reduce an amount of oil escaping into the atmosphere 500.

The operation of the hydrodynamic bearing motor having the above-mentioned construction will now be described. When power is applied to the stator 201, the rotor rotates about the shaft 210 due to an electromagnetic force acting between the stator 201 and the magnet 350. When the rotor rotates, a hydrodynamic pressure is generated among the thrust cover 230, the fixture 220, and the sleeve 310 to form the upper and lower thrust bearings 411 and 412 and the upper and lower journal bearings 413 and 414 between the inside diameter surface of the sleeve 310 and the shaft 210.

In this way, hydrodynamic bearings are formed by oil between the fixed stator and the rotor, thus allowing the rotor having the hub 320 in which a disc (not shown) is seated to stably rotate about the shaft 210.

Meanwhile, when air bubbles, generated due to heat generated when the motor operates, expand, as shown in FIG. 9, the air bubbles are collected at the intake hole 213 where a negative pressure is generated. That is, oil within the oil gap moves to the central portions of the oil grooves 216 and 217 around the upper and lower journal bearings 413 and 414, thus creating a dynamic pressure (solid arrow). On the other hand, the air bubbles move to a low pressure region, i.e., the negative pressure generating portion between the upper and lower journal bearings 413 and 414 (dotted arrow).

As shown in FIG. 6, the air bubbles collected at the negative pressure generating portion are discharged into the atmosphere 500 through the intake hole 213, the communicating hole 215, the discharge hole 214, the connecting hole 221 and the gap 205 communicating with the atmosphere 500.

This prevents leakage of oil by air bubbles and balances a pressure between upper and lower bearings by discharging the air bubbles generated at the upper and lower journal bearings 413 and 414 through the intake hole 213, thus allowing a smooth rotation of the motor.

Furthermore, when the sleeve 310 and the hub 320 rotate, oil collected in the upper and lower capillary seals 510 and 511 moves toward the upper and lower thrust bearings 411 and 412 due to a centrifugal force, thus preventing leakage of oil.

Oil escaping from the upper capillary seal 510 due to external shocks or vibrations is prevented again by the annular gap 520 from leaking out. On the other hand, air bubbles, expanded due to heat generated when the motor operates, are smoothly discharged into the atmosphere 500 through the pressure balancing hole 231, thus preventing leakage of oil collected in the annular gap 520.

The oil storing grooves 233 formed in the outer circumference of the thrust cover 230 provides a space in a path along which oil can escape into the atmosphere 500, further alleviating oil leakage.

Furthermore, the upper gap 530 serves to prevent entry of foreign materials and utilizes a centrifugal force to allow oil retained therein to enter the internal space, thereby preventing neighborhood contamination due to oil leakage.

Oil is injected into the oil gap after fixing the sleeve 310 to the shaft 310 and fitting the thrust cover 230 over the shaft 210. Because a constant amount of oil is always filled up to the upper and lower capillary seals 510 and 511, it is possible to provide motors having the same performance.

In the hydrodynamic bearing motor according to the present invention, since the upper and lower capillary seals 510 and 511 for preventing oil leakage are located at the outside of the sleeve 310, it is possible to provide a sufficient length of the journal bearings 413 and 414, thus reducing the occurrences of vibrations while allowing for a stable operation.

The hydrodynamic bearing motor of the present invention has several advantages. First, because the shaft 210 has the intake hole 213 and the discharge hole 214 communicating with the oil gap and the atmosphere 500 and the fixture 220 has the connecting hole 221 communicating with the discharge hole 214, it is possible to uniformly maintain a pressure between upper and lower bearings by discharging air bubbles generated when the motor operates and prevent leakage of oil by the expanded air bubbles, thus preventing neighborhood contamination and degradation of motor characteristics. Second, the presence of the upper and lower capillary seals 510 and 511 can effectively prevent leakage of oil when the motor stops operating or starts operating. Third, the pressure balancing hole 231 formed in the thrust cover 230 and connected with the upper capillary seal 510 also serves to prevent oil retained within the annular gap 520 from leaking out despite the presence of expanded air bubbles. Furthermore, the oil storing groove 233 formed in the outer circumference of the thrust cover 230 removes the movement of oil toward the atmosphere 500, further preventing the oil from leaking out.

Fourth, a constant amount of oil can be injected through the capillary seals 510 and 511, thus allowing for production of motors with the same performance. Fifth, because the upper and lower capillary seals 510 and 511 for preventing oil leakage are located at the outside of the sleeve 310, it is possible to provide a sufficient length of the journal bearings 413 and 414, thus allowing for a stable operation by reducing the occurrences of vibrations.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A hydrodynamic bearing motor wherein a sleeve rotates with respect to a shaft via upper and lower oil journal bearings formed between the shaft and the sleeve, the hydrodynamic bearing motor comprising:
an upper thrust cover that is fitted over a top portion of the shaft, forms an upper thrust bearing with a top portion of the sleeve, and has an annular rib extending downward to enclose the top portion of the sleeve;
a fixture that is secured to a bottom portion of the shaft, forms a lower thrust bewaring with a bottom portion of the sleeve, and has a receiving rib extending upward to enclose the bottom portion of the sleeve;
an upper capillary seal that is defined between an outer circumference of the top portion of the sleeve and the annular rib, communicates with the upper thrust bearing, and retains oil by capillary action; and.
a lower capillary seal that is defined between an outer circumference of the bottom portion of the sleeve and an inner circumference of the receiving rib, communicates with the lower thrust bearing, and retains oil by capillary action.

2. The hydrodynamic bearing motor of claim 1, wherein the upper capillary seal tapers toward the top portion of the sleeve, and
the lower capillary seal tapers toward the bottom portion of the sleeve.

3. The hydrodynamic bearing motor of claim 2, further comprising an annular flange extending from a top edge of a hub to form an upper gap with a top edge of the thrust cover; and
an annular gap formed between an inside diameter surface of the hub and an outside diameter surface of the annular rib.

4. The hydrodynamic bearing motor of claim 3, further comprising a pressure balancing hole that is formed in the annular rib of the thrust cover to allow communication between the upper capillary seal and the upper gap.

5. The hydrodynamic bearing motor of claim 3, further comprising an oil storing groove that is formed in an outer circumference of the annular rib in contact with the annular gap.

6. The hydrodynamic bearing motor of claim 2, wherein the shaft has an intake hole communicating with an oil gap between the upper and lower journal bearings, a discharge hole communicating with the atmosphere, and a communicating hole connecting between the intake hole and the discharge hole, and
wherein the fixture has a connecting hole providing a passage between the discharge hole and the atmosphere.
